(19) United States
(12) Patent Application Publication
(10) Pub. No.: US 2025/0149661 A1
(43) Pub. Date: May 8, 2025

(54) BATTERY CELL SELF-DISCHARGE DETECTION

(71) Applicant: GM Global Technology Operations LLC, Detroit, MI (US)

(72) Inventors: Andrew C. Baughman, Northville, MI (US); Shubham Gupta, Ann Arbor, MI (US); Rajeev M. Ramanan, Northville, MI (US); Xiumei Guo, Troy, MI (US)

(21) Appl. No.: 18/500,366

(22) Filed: Nov. 2, 2023

(51) Int. Cl. H01M 10/42

(52) U.S. Cl. CPC H01M 10/4257; H01M 10/4207; H01M 10/4285; H01M 2010/4271

(57) ABSTRACT

A power distribution system includes a battery having multiple power cell groups. Each power cell group includes at least two power cells and a state of charge monitoring sensor. A controller is connected to each state of charge monitoring sensor. The controller is configured to run a process causing the processor to detect a slow self-discharge in at least one power cell group by monitoring a cell balancing metric for each power cell group and generating a set of accumulated balance metric values. The set of accumulated balancing metric values includes an accumulated balancing metric value corresponding to each power cell group in the plurality of power cell groups. The process identifies a reference value and a difference between the reference value and the cell balancing metric of each power cell with a cell balancing metric lower than the reference value and comparing the difference to a threshold.

### INTRODUCTION

The subject disclosure relates to power cells for rechargeable batteries, such as those used in electric or hybrid electric vehicles, and more specifically to a process for detecting self-discharge in the same.

Vehicles, including electric and hybrid electric vehicles, feature battery storage for purposes such as powering electric motors, electronics and other vehicle subsystems. Batteries for the battery storage system typically include multiple distinct power cells, each of which stores power to a vehicle power distribution system. The power cells are electrically connected to provide an output power. Certain operational conditions, wear and tear, manufacturing variances, and other factors may result in one or more power cells within the battery storage system undergoing a self-discharge. A self-discharge is a depletion of the stored power, typically via a current loop, where the depletion is not the result of an external draw or a controller command. In some cases the self-discharge can be slow (have a low current), and be hard to detect via existing processes.

Accordingly, it is desirable to provide a system for detecting and responding to a slow self-discharge event in one or more power cells of a rechargeable battery.

### SUMMARY

In one exemplary embodiment a vehicle power distribution system includes a battery having a plurality of power cell groups, each power cell group including at least two power cells, and wherein each power cell group includes a state of charge monitoring sensor, a controller connected to each state of charge monitoring sensor, the controller including a non-transitory memory and a processor, the non-transitory memory being configured to run a process causing the processor to detect a slow self-discharge in at least one power cell group by monitoring a cell balancing metric for each power cell group in the at least two power cells and generating a set of accumulated balance metric values, the set of accumulated balance metric values including an accumulated balancing metric value corresponding to each power cell group in the plurality of power cell groups, identifying a reference value, identifying a difference between the reference value and the cell balancing metric value of each power cell with a cell balancing metric value lower than the reference value and comparing the difference to a threshold, and identifying a power cell group including a self discharging power cell in response to a power cell group having a cell balancing metric value below the reference value by at least the threshold.

In addition to one or more of the features described herein the cell balancing metric value is a balancing amp hours measurement.

In addition to one or more of the features described herein the reference value is an nth lowest cell balancing metric value in the set of accumulated balance metric values.

In addition to one or more of the features described herein the nth lowest cell balancing metric value is one of a 2nd lowest balance metric value and a 3rd lowest accumulated balance metric values.

In addition to one or more of the features described herein the reference value is one of a mean average accumulated balancing metric value in the set of accumulated balancing metric values, and a median average accumulated balancing metric value in the set of accumulated balancing metric values.

In addition to one or more of the features described herein the process is reiterated for a predetermined length of time.

In addition to one or more of the features described herein the process is reiterated for a predetermined number of iterations.

In addition to one or more of the features described herein the process causing the processor to detect a slow self-discharge in at least one power cell group is initiated in response to one of a completed cell balancing process and a determination that the power cell groups are balanced.

In another exemplary embodiment . . . a vehicle includes at least one electric drive motor, a power distribution system electrically connecting a battery system to the at least one electric drive motor and including at least one battery having a plurality of power cells divided into a plurality of power cell groups and a controller including a non-transitory memory and a processor, the non-transitory memory being configured to run a process causing the processor to detect a slow self-discharge in at least one power cell group by, monitoring a cell balancing metric for each power cell group in the plurality of power cell groups and generating a set of accumulated balance metric values, the set of accumulated balancing metric values including an accumulated balancing metric value corresponding to each power cell group in the plurality of power cell groups, identifying a reference value, identifying a difference between the reference value and the cell balancing metric of at each power cell with a cell balancing metric lower than the reference value and comparing the difference to a threshold, and identifying a power cell group including a self discharging power cell in response to a cell in a power cell group having a balancing metric below the reference value by at least the threshold.

In addition to one or more of the features described herein the balancing metric is a balancing amp hours measurement.

In addition to one or more of the features described herein the reference value is an nth lowest balancing metric value in the set of accumulated balance metric values.

In addition to one or more of the features described herein the nth lowest balancing metric value is one of a 2nd lowest balance metric value or a 3rd lowest accumulated balance metric values.

In addition to one or more of the features described herein the reference value is one of a mean average accumulated balancing metric value in the set of accumulated balancing metric values, and a median average accumulated balancing metric value in the set of accumulated balancing metric values.

In another exemplary embodiment method for identifying a self-discharge in a power cell group of a battery includes monitoring a cell balancing metric for each power cell group in a plurality of power cell groups and generating a set of values corresponding to a total accumulated cell balancing metric of each power cell group in the plurality of power cell groups, comparing each value in the set of values below a reference value to the reference value and identifying a self-discharging power cell group in the set of power cell groups when at least one value in the set of values is below the reference value by at least a threshold amount.

In addition to one or more of the features described herein the cell balancing metric for a given power cell group in the plurality of power cell groups is a magnitude of balancing amp hours discharged from the given power cell group.

In addition to one or more of the features described herein the reference is an nth lowest balancing metric value in the set of accumulated balance metric values.

In addition to one or more of the features described herein the nth lowest balancing metric value is one of a 2nd lowest balance metric value or a 3rd lowest accumulated balance metric values.

In addition to one or more of the features described herein the reference value is one of a mean average accumulated balancing metric value in the set of accumulated balancing metric values, or median accumulated balancing metric value in the set of accumulated balancing metric values.

In addition to one or more of the features described herein the method is reiterated for a predetermined length of time.

In addition to one or more of the features described herein the method is reiterated for a predetermined number of iterations.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a battery-based energy storage system;

FIG. 2 is an exemplary rechargeable battery according to one embodiment;

FIG. 3 is an exemplary process for an initial balancing of power cell groups in a rechargeable battery; and

FIG. 4 is an exemplary process for identifying a self-discharging power cell group within a rechargeable battery.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with an exemplary embodiment, a controller (such as a battery system controller or other vehicle controller) monitors a state of charge of each group of power cells within a rechargeable battery. The controller periodically balances the states of charge of the groups of power cells (power cell group) such that each power cell group has approximately the same state of charge. Balancing is achieved by discharging from any groups of power cells exceeding the state of charge of the lowest power cell groups until the states of charge are within a threshold amount of each other. The controller monitors the total amount discharged from each power cell groups over time. After a predetermined amount of time, or a predetermined number of balancing operations, has occurred, a statistical analysis is performed to identify any groups of power cells that have consistently been lower than the remainder of the power cells at each rebalancing. Any power cells meeting this condition are identified as including a slow self-discharge and an appropriate response is initiated by the controller.

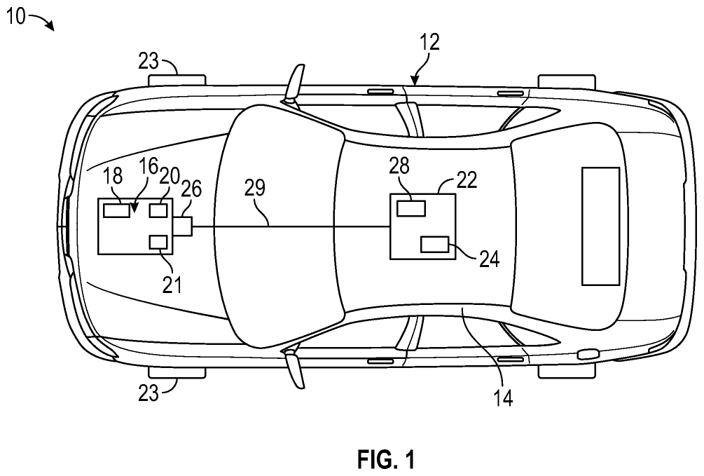

With continued reference to the general process described above, FIG. 1 shows an embodiment of a motor vehicle 10 including a battery system controller 24 configured to control a battery system 22 and configured to implement the process for detecting a slow self-discharge in a power cell. The vehicle 10 includes a vehicle body 12 defining, at least in part, an occupant compartment 14. The vehicle body 12 also supports various vehicle subsystems including a propulsion system 16, the battery system 22, other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. For example, the propulsion system 16 includes a first electric motor 20 and a second electric motor 21. The motors 20 and 21 may be configured to drive wheels 23 on opposing sides of the vehicle 10. Any number of motors positioned at various additional locations about the vehicle 10 may be used to provide mechanical rotation to corresponding systems and subsystems.

The battery system 22 may be electrically connected to the motors 20 and 21 and/or other components, such as vehicle electronics. The battery system 22 may be configured as a rechargeable energy storage system (RESS), and includes multiple electrically connected power cells divided into power cell groups. The battery system controller 24 is included within the battery system 22 and controls the charging and discharging functions of the batteries within the battery system 22. In alternative configurations, the battery system controller 24 can be a general vehicle controller remote from the battery system 22 and configured to control multiple systems and/or subsystems. The general vehicle controller can be located at any position within the vehicle 10. In yet further alternatives, the battery system controller 24 can be a distributed control system including multiple coordinating controllers throughout the vehicle 10 encompassing controllers within the battery system 22 and controllers remote from the battery system 22.

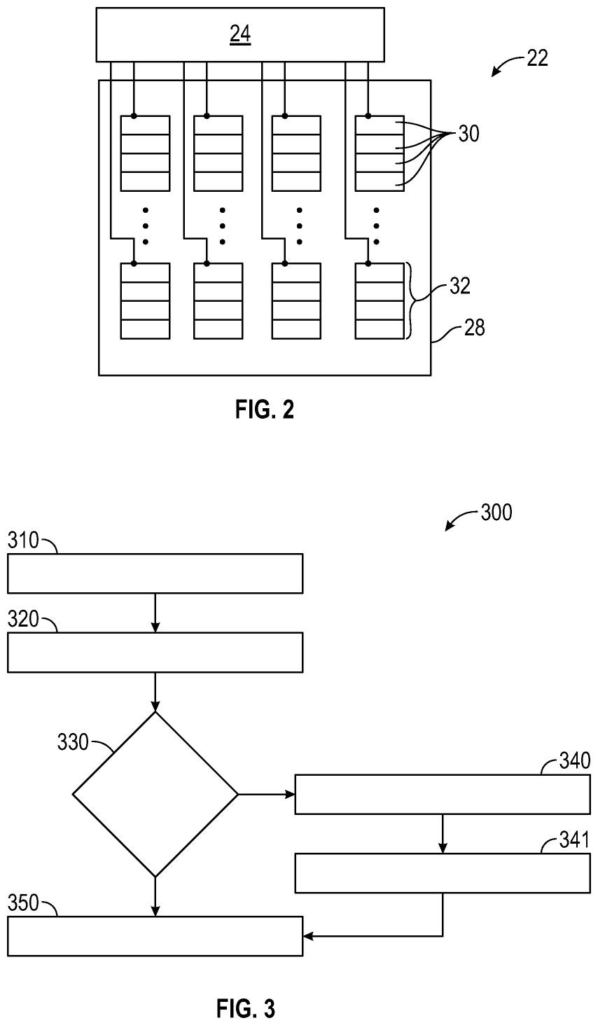

In one embodiment, the battery system 22 includes one or more battery packs 28. The battery packs 28 include multiple distinct power cells 30, see FIG. 2, connected to a power distribution bus 29 for providing power to one or more systems. In the exemplary system of FIG. 1, the power distribution bus 29 is illustrated in simplified form and provides power to the propulsion systems 16 through an inverter 26.

With continued reference to FIG. 1, FIG. 2 schematically illustrates the battery system 22 of FIG. 1 in more detail. The power cells 30 are distributed into power cell groups 32, with each power cell group 32 including the same number and capacity of power cells 30. In alternative embodiments, it is conceived that varying numbers or configurations of power cells 30 can be in each group 32, with each group 32 having the same total state of charge capacity. A state of charge of each group is monitored and provided to the controller 24, and the controller 24 includes processes and systems for reacting to the state of charge measurements and controlling states of charge of the groups 30.

In some cases one or more of the power cell groups 32 can include a power cell 30 having a slow self discharge condition causing the power cell 30 to slowly discharge power, independent of any draw on the power cell group 32. Existing monitoring systems and sensors are configured to detect fast self discharges where the current is high and the discharge occurs fast. When a power cell 30 includes contamination within the power cell 30, dendrites have just begun to pierce layers of the power cell 30, manufacturing defects or other similar conditions are present within the power cell 30, a low current self-discharge can occur. Low current self discharges when undetected can result in a malfunction of the power cell which may cascade into other power cells within the power cell group or other components within the power distribution system.

One example control process that can be performed by the controller 24 is power cell 30 balancing, one example of which is illustrated at FIG. 3. When the battery system 22 initializes, in an initialization step 310, the controller 24 identifies the power cell group 32 with the lowest state of charge and compares the state of charge of each other power cell group 32 to the state of charge of the identified power cell group 32 in a check State of Charge (SOC) levels step 320.

The controller 24 determines if any cell in a power cell group 32 are out of balance by determining if the cells exceed the state of charge of the lowest state of charge cell in power cell group 32 by at least a threshold amount in an Are Cells Out Of Balance check 330. When one or more cells in power cell group 32 are out of balance, the process 300 discharges energy from the out of balance cells in power cell group 32 until the out of balance cells in power cell group 32 fall within the threshold amount of the lowest state of charge cell in power cell group 32 in a Balance Cells step 340. Once either the initially-calculated imbalance has been balanced in a Balance Completed step 341 or when the controller determines that no cells in the power cell group 32 are out of balance at the Are Cells Out Of Balance check 330, the controller 24 completes a first cell balance and internally flags the cells in the power cell group 32 as balanced.

Once this is complete the controller 24 begins a self-discharge diagnostic process 350.

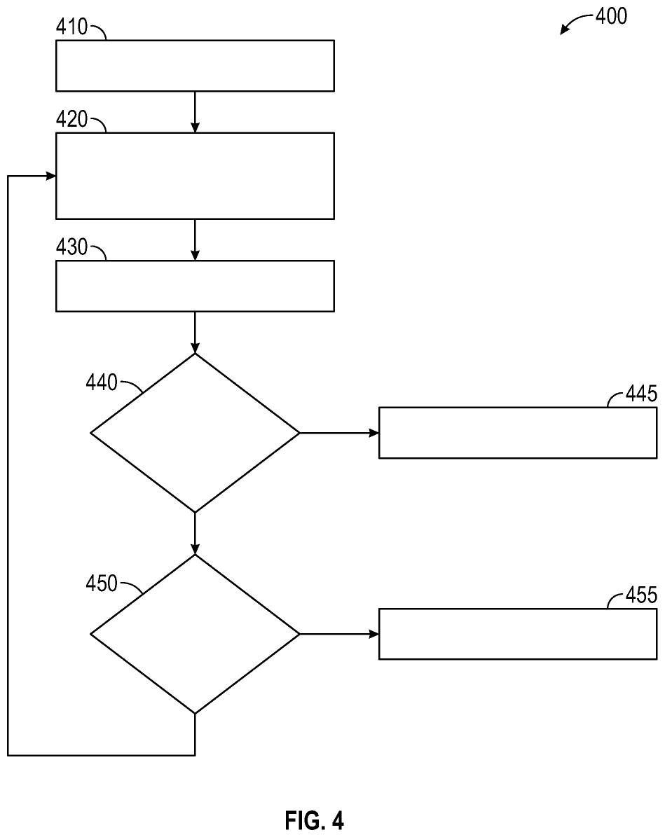

With continued reference to FIGS. 1-3, FIG. 4 illustrates a self-discharge diagnostic process 400 according to one example. In some examples, the process 400 is initiated at the conclusion of an initial balancing operation, such as the process 300 described in FIG. 3. The self-discharge diagnostic begins by starting a time window at step 410. The time window can be a predetermined duration of time (e.g., two months), or a predetermined number of balancing iterations for the battery system 22.

Each time the controller 24 rebalances the groups 32 during the time window, the number of balancing hours for each group 32 are accumulated at step 420. In one example, the number of balancing hours is a total amp hours that are discharged due to the balancing operation. In alternative examples, alternative units corresponding to a magnitude of energy removed from each group 32 during the balancing operation can be used to track the balancing hours for each group 30.

The number of amp hours discharged for a given iteration is added to a total number of amp hours for the group 32 to generate an accumulated total.

After accumulating the balancing hours, the controller 24 determines a residual value in a Determine Reference step 430, with the residual value being calculated from the reference. The residual value is the difference between a reference point (e.g. a second lowest balancing amount) and the lowest cell balancing amounts (in amphours).

If the residual value within power cell groups 32 is more than a threshold magnitude, this is indicative of a self-discharge cell occurring within the power cell group 32.

In some examples, the reference is a predetermined reference point. Predetermined reference points can include: the n^{th} worst cell in power cell group 32 (e.g., the 2^{nd} worst in group 32, the 3^{rd} worst in group 32, etc.), or a mean average balancing amphours, and a median average balancing hours. Alternative predetermined reference points can likewise be used to similar effect. In other examples, the reference point can be dynamic and shift based on energy in the battery pack. In one such example, the reference point is set at a lowest cell in power cell group 32 that is higher than the largest gap between cells in power cell groups 32.

In addition, the threshold can either be a predefined deviation, or a dynamic deviation with the threshold depending on spread accumulation. In one such example, if spread accumulation is in the early stages then the threshold is larger than the maximum spread between cells in power cell groups 32. Once it is determined that enough time has elapsed for accumulating a balancing hours spread in power cell groups 32, the threshold is adjusted in response to the growing spread to identify a self discharging cell in power cell group 32. Specific values and correlations will depend on the particular system and may be determined via empirical testing during the design phase.

Once a reference point and a threshold are determined, the controller 24 compares every cell in power cell group 32 below the reference point to the threshold in a check 440. If any cell in power cell group 32 has a lower total balancing hours than the reference point by at least the threshold, the controller 24 determines that the cell 30 in the power cell group 32 include a self-discharge, and that power cell group 32 is failed in a step 445.

If no cells in power cell groups 32 has a lower total balancing hours than the reference by at least the threshold amount, than the process 400 checks to see if the time window has elapsed in a check 450. If the time window has fully elapsed, the controller 24 determines that no power cell groups 32 have failed the diagnostic in a pass step 455. When the time window has not elapsed, the process returns to the accumulate balancing hours step 420 and reiterates from there.

Once a power cell group 32 is determined to have failed, the controller 24 takes one or more remedial actions designed to either allow continued operation of the vehicle, provide a limp home mode of operations, or safely shuts down the vehicle. In one example, the potential risks associated with a self-discharge are mitigated by enforcing a limit on the maximum state of charge on the battery power cell groups 32, or on the individual cell 30 including a self-discharge. By way of example, the maximum state of charge could be a percentage (e.g. a maximum possible state of charge of 30%) or a hard cap (e.g., a maximum possible state of charge of 50V). In this case, the risk of self-discharge is mitigated by minimizing the amount of power that can be is charged due to self-discharge events, and the vehicle is allowed to continue operating at a reduced range.

In another example, where a power cell group 32 is identified and independently controlled, the identified power cell group 32 can be electrically isolated from a remainder of the battery system until it can be replaced, and the vehicle is allowed to continue operating.

In yet another example the controller 24 can notify the driver of an impending shut down, and disable the battery 22, thereby ensuring that no further power is dissipated through the self-discharge occurrences while allowing the driver to maneuver to a safe location for a vehicle shut down.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless specified to the contrary within, schematic representations do not correspond one to one with physical structures, and the relative positioning, size, orientation, or other configurations of the components within the schematic representation are not limiting.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle power distribution system comprising:
a battery having a plurality of power cell groups, each power cell group including at least two power cells, and wherein each power cell group includes a state of charge monitoring sensor;
a controller connected to each state of charge monitoring sensor, the controller including a non-transitory memory and a processor, the non-transitory memory being configured to run a process causing the processor to detect a slow self-discharge in at least one power cell group by:
monitoring a cell balancing metric for each power cell group in the at least two power cells and generating a set of accumulated balance metric values, the set of accumulated balance metric values including an accumulated balancing metric value corresponding to each power cell group in the plurality of power cell groups;
identifying a reference value;
identifying a difference between the reference value and the cell balancing metric value of each power cell with a cell balancing metric value lower than the reference value and comparing the difference to a threshold; and
identifying a power cell group including a self discharging power cell in response to a power cell group having a cell balancing metric value below the reference value by at least the threshold.

2. The vehicle power distribution system of claim 1, wherein the cell balancing metric value is a balancing amp hours measurement.

3. The vehicle power distribution of claim 1, wherein the reference value is an nth lowest cell balancing metric value in the set of accumulated balance metric values.

4. The vehicle power distribution system of claim 3, wherein the nth lowest balancing metric value is one of a 2^{nd} lowest balance metric value and a 3^{rd} lowest accumulated balance metric values.

5. The vehicle power distribution system of claim 1, wherein the reference value is one of a mean average accumulated balancing metric value in the set of accumulated balancing metric values, and a median average accumulated balancing metric value in the set of accumulated balancing metric values.

6. The vehicle power distribution system of claim 1, wherein the process is reiterated for a predetermined length of time.

7. The vehicle power distribution system of claim 1, wherein the process is reiterated for a predetermined number of iterations.

8. The vehicle power distribution system of claim 1, wherein the process causing the processor to detect a slow self-discharge in at least one power cell group is initiated in response to one of a completed cell balancing process and a determination that the power cell groups are balanced.

9. A vehicle comprising:
at least one electric drive motor;
a power distribution system electrically connecting a battery system to the at least one electric drive motor and including at least one battery having a plurality of power cells divided into a plurality of power cell groups and a controller including a non-transitory memory and a processor, the non-transitory memory being configured to run a process causing the processor to detect a slow self-discharge in at least one power cell group by:
monitoring a cell balancing metric for each power cell group in the plurality of power cell groups and generating a set of accumulated balance metric values, the set of accumulated balancing metric values including an accumulated balancing metric value corresponding to each power cell group in the plurality of power cell groups;
identifying a reference value;
identifying a difference between the reference value and the cell balancing metric of at each power cell with a cell balancing metric lower than the reference value and comparing the difference to a threshold; and
identifying a power cell group including a self discharging power cell in response to a cell in a power cell group having a balancing metric below the reference value by at least the threshold.

10. The vehicle of claim 9, wherein the balancing metric is a balancing amp hours measurement.

11. The vehicle of claim 9, wherein the reference value is an nth lowest balancing metric value in the set of accumulated balance metric values.

12. The vehicle of claim 11, wherein the nth lowest balancing metric value is one of a 2^{nd} lowest balance metric value or a 3^{rd} lowest accumulated balance metric values.

13. The vehicle of claim 9, wherein the reference value is one of a mean average accumulated balancing metric value in the set of accumulated balancing metric values, and a median average accumulated balancing metric value in the set of accumulated balancing metric values.

14. A method for identifying a self-discharge in a power cell group of a battery comprising:
monitoring a cell balancing metric for each power cell group in a plurality of power cell groups and generating a set of values corresponding to a total accumulated cell balancing metric of each power cell group in the plurality of power cell groups;
comparing each value in the set of values below a reference value to the reference value and identifying a self-discharging power cell group in the set of power cell groups when at least one value in the set of values is below the reference value by at least a threshold amount.

15. The method of claim 14, wherein the cell balancing metric for a given power cell group in the plurality of power cell groups is a magnitude of balancing amp hours discharged from the given power cell group.

16. The method of claim 14, wherein the reference is an nth lowest balancing metric value in the set of accumulated balance metric values.

17. The method of claim 16, wherein the nth lowest balancing metric value is one of a 2^{nd} lowest balance metric value or a 3^{rd} lowest accumulated balance metric values.

18. The method of claim 14, wherein the reference value is one of a mean average accumulated balancing metric value in the set of accumulated balancing metric values, or median accumulated balancing metric value in the set of accumulated balancing metric values.

19. The method of claim 14, wherein the method is reiterated for a predetermined length of time.

20. The method of claim 14, wherein the method is reiterated for a predetermined number of iterations.
